(19) United States
(12) Patent Application Publication
(10) Pub. No.: US 2007/0089898 A1
(43) Pub. Date: Apr. 26, 2007

(54) Multi-sheath multi-conductor cable

(75) Inventor: Thomas R. Potter SR., Reno, NV (US)

Correspondence Address: Warren P. Kujawa, 461 Indigo Springs St, Henderson, NV, 89014, US

(73) Assignee: RENO AGRICULTURE AND ELECTRONICS, Reno, NV (US)

(21) Appl. No.: 11/256,490

(22) Filed: Oct. 22, 2005

(51) Int. Cl. H01B 11/02

(52) U.S. Cl. 174/113 R

(57) ABSTRACT

A multi-sheath multi-conductor cable for use as an oscillator loop. The cable has a plurality of inner wires each having an insulative jacket. An inner electrically insulative flexible sheath surrounds the jacketed wires. A water blocking compound occupies the voids in the volume defined by the inner sheath. A first outer sheath surrounds the inner sheath. A second outer sheath surrounds the first outer sheath. Both outer sheaths are electrically insulative and sufficiently flexible to enable the cable to be formed into a loop having angled corners.

### BACKGROUND OF THE INVENTION

This invention relates to multi-conductor electrical cables. More particularly, this invention relates to a multi-conductor electrical cable used as the oscillator loop in a vehicle detector system.

Vehicle detectors have been used for a substantial period of time to generate information specifying the presence or absence of a vehicle at a particular location. Such detectors have been used at intersections, for example, to supply information used to control the operation of the traffic signal heads; have been used in railway installations for railway car detection and control; and have also been used to supply control information used in conjunction with automatic entrance and exit gates in parking lots, garages and buildings.

A widely used type of vehicle detector employs the principle of period shift measurement in order to determine the presence or absence of a vehicle in or adjacent an inductive loop mounted on or in a roadbed. In such systems, a first oscillator, which typically operates in the range from about 10 kHz to about 120 kHz is used to produce a periodic signal in a vehicle detector loop. A second oscillator operating at a much higher frequency is commonly used to generate a sample count signal over a selectable, fixed number of loop cycles. The relatively high frequency count signal is typically used to increment a counter, which stores a number corresponding to the sample count at the end of the fixed number of loop cycles. This sample count is compared with a reference count stored in another counter and representative of a previous count in order to determine whether a vehicle has entered or departed the region of the loop in the time period between the previous sample count and the present sample count.

A key element in any vehicle detector system is the vehicle detector inductive loop. This element comprises a multi-turn conductor which is connected at both ends to the vehicle detector oscillator circuit. While the oscillator circuit is normally protected by a cabinet enclosure, the inductive loop must be positioned in an area over which vehicles will pass. For installations having a paved surface, the inductive loop is usually positioned within a rectangular slot formed in the pavement, and covered with a sealing material such as an epoxy compound. For installations not having a paved surface, the inductive loop is either buried in a shallow trench in the earth or arranged on the surface, such as the surface of a rail bed having raised ties in a rail road application.

In all types of installations, the inductive loop is subject to exposure to the environment-either directly (as in the case of an inductive loop buried in a trench or arranged on the surface), or indirectly (as in the case of an inductive loop located in a sealed pavement slot). In all cases, this exposure to the environment results in severe thermal stresses, which can cause mechanical failure. In addition, the inductive loop is subjected to widely varying moisture conditions due to variations in humidity and direct exposure to intruding water.

In the past, many different types of cables have been devised for use as inductive loops for vehicle detector systems. Currently, a widely used cable design has a multi-conductor core of individual electrically conductive wires each surrounded by a cross-linked polyethylene jacket. This core is surrounded by a close fitting cross-linked polyethylene sheath, and a water blocking tacky substance is introduced into the inner spaces between the inner surface of the sheath and the individual jacketed wires to provide a moisture barrier.

This cable design has been in use for several years and has proven to be a durable construction providing long life and reliable electrical operation.

In spite of the relative success experienced with the above cable design, failures have been reported in installations affected by extreme environmental conditions, particularly in rail road applications. Due to the exposure of the cable to rough surfaces, such as the ballast used in rail road beds, and movement caused by passing vehicles, such as rail cars, the outer sheath and the internal jackets surrounding the individual wires can be worn away, causing electrical shorts or complete wire breakage. When this occurs, the cable must be replaced with a fresh cable.

Efforts in the past to provide additional protection to such cables have involved adding an outer protective layer of PVC pipe or rubber hose. However, these efforts have not been successful. The PVC pipe is a relatively brittle material which can easily crack under stress; rubber hose does not fit snugly around the outer sheath of existing cables. Thus, efforts to improve the performance of known multi-conductor sheath cables have not met with success to date.

### SUMMARY OF THE INVENTION

The invention comprises a multi-sheath multi-conductor cable which affords greater protection for the internal core wires and is capable of withstanding greater mechanical stresses over long periods of time without adverse effect to the electrical performance of the cable.

In a broadest aspect, the invention comprises a multi-sheath multi-conductor cable having a plurality of electrically conductive wires; a plurality of electrically insulative jackets each surrounding a different one of said plurality of electrically conductive wires; an inner electrically insulative flexible sheath surrounding said plurality of electrically conductive wires and electrically insulative jackets; and an electrically insulative flexible sheath surrounding said inner sheath. In a preferred embodiment the cable includes a second electrically insulative flexible sheath surrounding said electrically insulative flexible sheath.

The two outer electrically insulative flexible sheaths are preferably formed from a thermoplastic rubber compound or a thermoplastic elastomer compound.

The inner electrically flexible insulative sheath and each of said jackets preferably comprise a cross-linked polyethylene material.

The invention further preferably includes a water blocking material occupying any voids within the volume enclosed by said inner inner electrically flexible insulative sheath.

The invention provides a cable construction which provides enhanced durability when exposed to the environment for prolonged periods of time, with excellent mechanical anti-abrasion characteristics and substantial additional electrically insulative properties, while affording sufficient flexibility to enable loops with corner angles to be formed from the cable. The cable is especially suitable for use as the inductive loop in a vehicle detector system.

For a fuller understanding of the nature and advantages of the invention, reference should be had to the ensuing detailed description taken in conjunction with the accompanying drawings.

### BRIEF DESCRIPTION OF THE DRAWINGS

FIG. 1 is a side elevational view of a first embodiment of the invention;

FIG. 2 is a longitudinal sectional view of the FIG. 1 embodiment of the invention;

FIG. 3 is a cross-sectional view of the FIG. 1 embodiment of the invention;

FIG. 4 is a schematic diagram illustrating various placements of a vehicle detector loop cable according to the invention;

FIG. 5 is a schematic top plan view illustrating various loop placements in a rail road installation of the loop cable;

FIG. 6 is a side elevational view of a second embodiment of the invention;

FIG. 7 is a longitudinal sectional view of the FIG. 6 embodiment of the invention; and

FIG. 8 is a cross-sectional view of the FIG. 6 embodiment of the invention;

### DETAILED DESCRIPTION OF THE PREFERRED EMBODIMENTS

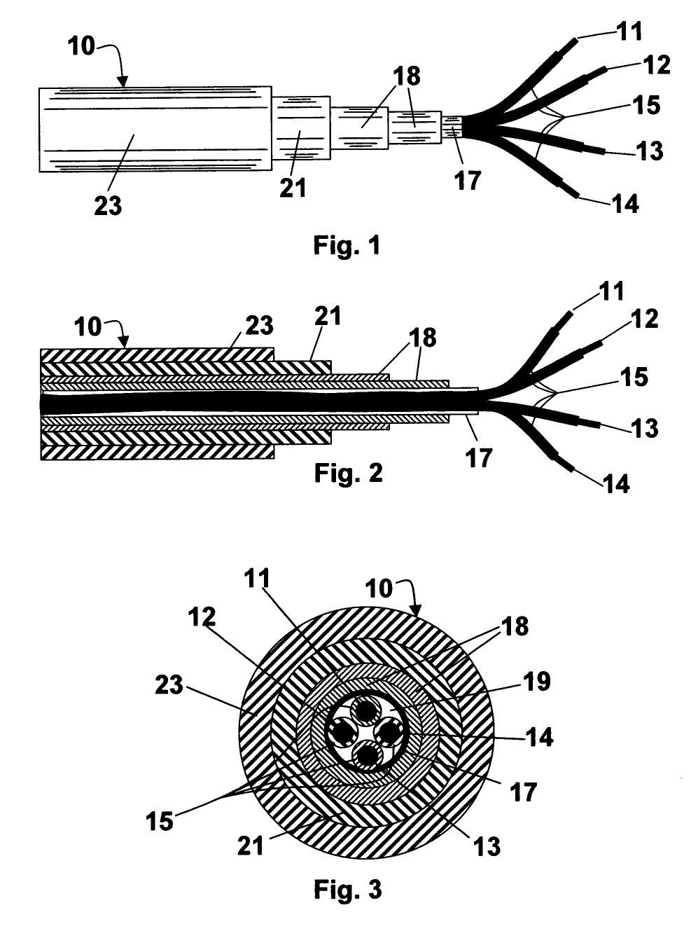

Turning now to the drawings, FIGS. 1-3 illustrate a first embodiment of the invention. As seen in these Figs., a multi-sheath multi-conductor cable 10 has an inner core comprising four individual electrically conductive wires 11-14 each having a jacket 15. Wires 11-14 are preferably 18 gauge wires fabricated from copper or any other electrically conductive material having good electrical conductivity. Jackets 15 are preferably cross-linked polyethylene material molded around wires 11-14.

The jackets 15 of the four wires 11-14 are preferably wrapped with an insulative binder tape 17, and this subassembly is surrounded by a two-layer cross-linked polyethylene inner sheath 18. The interstices between the individual wire jackets 15 and the inner surface of sheath 18 are filled with a water blocking material 19. Water blocking material 19 is preferably a wax-like material which is injected into the interstices at a relatively high temperature (typically about 400 degrees F.), and then allowed to cool. A preferred water blocking material 19 is a compound termed a cable flooding and filling compound sold under the designation SOLARIZE KM-2756 by Solar Compounds Corporation of Linden, N.J. Other suitable water blocking compounds may occur to those skilled in the art.

Surrounding inner sheath 18 is an intermediate sheath 21 and an outer sheath 23. Sheath 21 is molded about inner sheath 18, while outer sheath 23 is molded about intermediate sheath 21. Both sheaths 21, 23 are fabricated from the same rubber-like compound. A preferred compound is a material sold under the designation Elexar 8451, which is an S-EB-S styrene block copolymer based elastomer which can be processed with the speed and economy of a thermoplastic material and which exhibits good electrically insulative properties along with flexibility and mechanical durability. This compound is usually referred to as a thermoplastic rubber compound or a thermoplastic elastomer compound. The properties of this material which are important for the fabrication of cable 10 are good electrical insulation and flexibility, so that the cable 10 can be formed into a rectangular loop. Further properties for this material are set forth in a specification sheet for this product, which is available from Teknor Apex Company of Pawtucket, R.I. Other suitable materials for fabricating sheaths 21, 23 may occur those skilled in the art.

The outer diameter of cable 10 in a specific embodiment referred is ¾ inch. The outer diameter of inner sheath 18 is ⅜ inch.

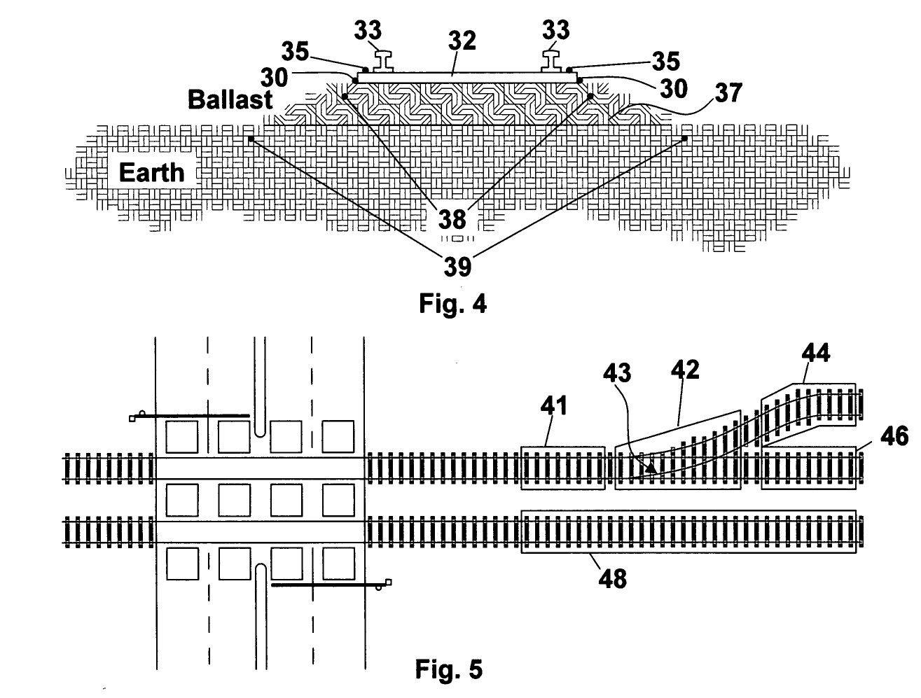

FIG. 4 illustrates several different ways that a loop formed from able 10 can be arranged in a rail road installation. As seen in this Fig., loop 30 formed from cable 10 is positioned on the top surfaces of rail load ties 32 outboard of rails 33. A second arrangement of a loop formed from cable 10 is loop 35, which is positioned on the upper surface of ballast 37 outboard of rail road ties 32. A third arrangement is illustrated by loop 38, which is buried in ballast 37. A fourth arrangement is illustrated by loop 39, which is buried in the earth below ballast 37.

FIG. 5 illustrates several different representative loop configurations at locations along railroad tracks. A first loop 41 is a short rectangular loop. A second loop 42 has a trapezoidal shape and encompasses the area occupied by two sets of rail road tracks joined at a switch junction 43. A third loop 44 has an irregular geometrical configuration which encompasses a set of rail which are curved. A fourth loop 46 46 has a rectangular configuration similar to loop 41. A fifth loop 48 has a long rectangular configuration. Each of loops 41, 42, 44, 46, and 48 may be located at any one of the elevations shown in FIG. 4.

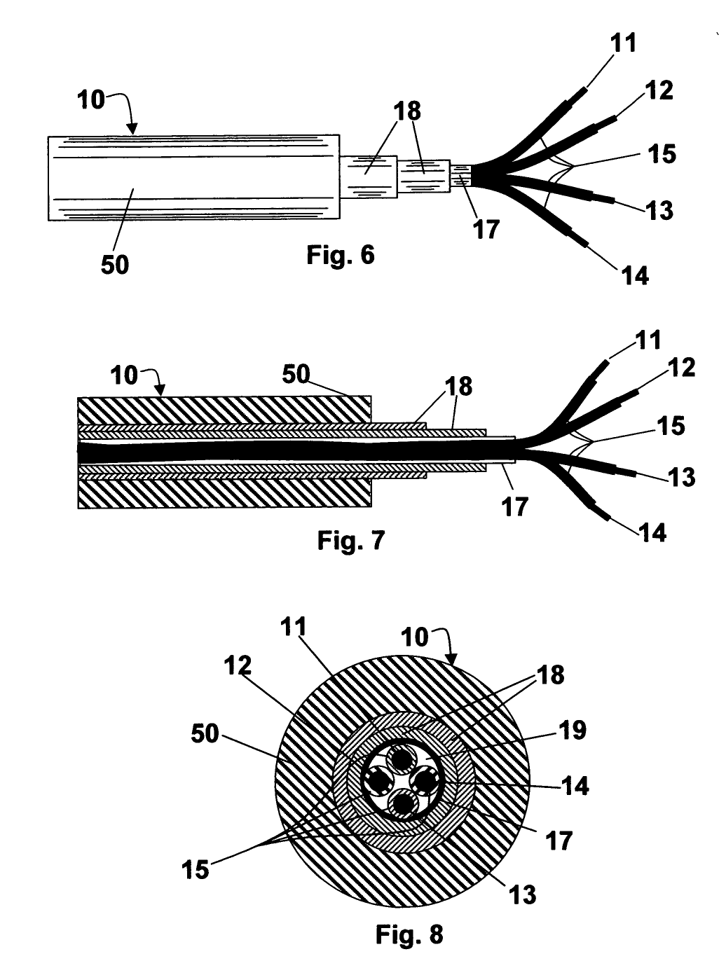

FIGS. 6-8 illustrate an alternate embodiment of the invention. This embodiment differs from the embodiment of FIGS. 1-3 by having a single outer sheath 50 which is bonded to and surrounds inner sheath 18. Sheath 50 is fabricated from the same material as sheaths 21, 23. The remaining elements of the embodiment of FIGS. 6-8 are identical to the embodiment of FIGS. 1-3.

Cables fabricated according to the teachings of the invention provide greater durability in situ than prior art cables of the type described above. Such cables are more resistant to mechanical abrasion and provide greater electrical insulation than known cables, while possessing sufficient flexibility to permit forming loops with angled corners. Cable 10 is ideally suited for use as a muti-turn loop for a vehicle detector.

Although the above provides a full and complete disclosure of the preferred embodiments of the invention, various modifications, alternate constructions and equivalents will occur to those skilled in the art. For example, while the invention gas been described with reference to specific compounds, other equivalent materials may be employed by those of skill in the art. Therefore, the above should not be construed as limiting the invention, which is defined by the appended claims.

1. A vehicle detector system comprising:
an oscillator for generating a periodic signal used to detect the presence or absence of a vehicle in or adjacent an inductive loop area, and
a multi-sheath multi-conductor cable formed into a loop of a selected geometrical shape and electrically connected to said oscillator to provide a loop inductance for said oscillator, said cable comprising:
a plurality of electrically conductive wires;
a plurality of electrically insulative jackets each surrounding a different one of said plurality of electrically conductive wires;
an inner electrically flexible insulative sheath surrounding said plurality of electrically conductive wires and electrically insulative jackets; and
an electrically insulative flexible sheath surrounding said inner sheath.

2. The invention of claim 1 further including a second electrically insulative flexible sheath surrounding said electrically insulative flexible sheath.

3. The invention of claim 2 wherein said second electrically insulative flexible sheath is formed from a thermoplastic rubber compound.

4. The invention of claim 2 wherein said second electrically insulative flexible sheath is formed from a thermoplastic elastomer compound.

5. The invention of claim 1 wherein said inner electrically flexible insulative sheath comprises a cross-linked polyethylene material.

6. The invention of claim 1 wherein said electrically insulative flexible sheath surrounding said inner sheath is formed from a thermoplastic rubber compound.

7. The invention of claim 1 wherein said electrically insulative flexible sheath surrounding said inner sheath is formed from a thermoplastic elastomer compound.

8. The invention of claim 1 further including a water blocking material occupying any voids within the volume enclosed by said inner electrically flexible insulative sheath.

9. The invention of claim 1 wherein each of said jackets comprises a cross-linked polyethylene material.

10. The invention of claim 1 wherein said cable is devoid of an electrically conductive sheath.

11. The invention of claim 1 wherein said preselected geometrical shape is rectangular.

12. The invention of claim 1 wherein said preselected geometrical shape is square.

13. The invention of claim 1 wherein said preselected geometrical shape is trapezoidal.

14. The invention of claim 1 wherein said loop is positioned in a recess in a roadbed.

15. The invention of claim 14 wherein said roadbed is paved; and wherein said aperture is a slot formed in said roadbed.

16. The invention of claim 14 wherein said roadbed is unpaved; and wherein said aperture is a trench formed in said roadbed.

17. The invention of claim 1 wherein said loop is positioned on a railroad bed.

18. The invention of claim 17 wherein said railroad bed has a plurality of railroad ties having a top surface; and wherein said loop is positioned on said top surface of said railroad ties.

19. The invention of claim 17 wherein said railroad bed has a plurality of railroad ties supported by ballast; and wherein said loop is positioned on said ballast outboard of said railroad ties.

20. The invention of claim 17 wherein said railroad bed has a plurality of railroad ties supported by ballast; and wherein said loop is buried underneath said railroad ties
